(19) United States
(12) Patent Application Publication
(10) Pub. No.: US 2024/0426601 A1
(43) Pub. Date: Dec. 26, 2024

(54) OPTICAL MEASURING DEVICE AND METHOD FOR THE THREE-DIMENSIONAL OPTICAL MEASUREMENT OF OBJECTS WITH A SENSOR UNIT FOR DETECTING OTHER OBJECTS IN THE CORRESPONDING SENSOR RANGE

(71) Applicant: Carl Zeiss GOM Metrology GmbH, Braunschweig (DE)

(72) Inventors: Thorsten Bothe, Braunschweig (DE); Tim Evers, Braunschweig (DE); Mladen Gomercic, Braunschweig (DE); Frank Peeters; Florian Gebhardt, Braunschweig (DE)

(21) Appl. No.: 18/820,191

(22) Filed: Aug. 29, 2024

Related U.S. Application Data
(63) Continuation of application No. PCT/EP2023/054704, filed on Feb. 24, 2023.

(30) Foreign Application Priority Data
Mar. 2, 2022 (DE) 10 2022 104 912.4

(51) Int. Cl. G01B 11/25; G01S 13/04

(52) U.S. Cl. CPC G01B 11/25; G01S 13/04

(57) ABSTRACT

An optical measuring device for the three-dimensional optical measurement of objects includes a device housing in which a projection unit for projecting a measuring structure onto the surface of the object to be measured in a projection area and a camera unit configured to capture images of the object provided with the projected measuring structure are integrated. The device housing also has a sensor unit configured to detect persons in a sensor range covered by the sensor unit. The optical measuring device is configured to limit the light intensity to a level that is not dangerous for a person located in a danger area of the projection area when the presence of a person in the sensor area or part of the sensor area has been detected.

### CROSS REFERENCE TO RELATED APPLICATIONS

This application is a continuation application of international patent application PCT/EP2023/054704 filed on Feb. 24, 2023, designating the United States and claiming priority to German application 10 2022 104 912.4, filed Mar. 2, 2022, and the entire content of these applications is incorporated herein by reference.

### TECHNICAL FIELD

The disclosure relates to an optical measuring device for the three-dimensional optical measurement of objects, wherein the optical measuring device has a device housing, in which a projection unit for projecting a measurement structure onto the surface of the object to be measured in a projection region and a camera unit for recording images of the object provided with the projected measurement structure are integrated.

The disclosure furthermore relates to a method for the three-dimensional optical measurement of objects with such an optical measuring device.

### BACKGROUND

The three-dimensional optical capture of object surfaces with optical sensors according to the principle of triangulation is sufficiently known. In this case, patterns, in particular stripe patterns, are projected onto the object to be measured. The backscattered pattern is recorded by one or more image recording units and subsequently evaluated by an image evaluation unit.

The patterns projected by the projection unit may be configured in a variety of different ways. Typical projected patterns are stochastic patterns and also regular patterns, e.g., point and stripe patterns. Stripe patterns, in particular, have become established as customary patterns in the context of optical 3D measurement.

The projected pattern gives rise to an artificial, temporary texture on the object to be measured. This texture is captured by the camera unit, which may have one or more cameras (generally also referred to as image recording unit). With the aid of the artificially generated texture that is generally known a priori, 3D points on the object to be measured can be identified unambiguously in both the projection unit and the camera unit.

The 3D coordinates can be determined with a triangulation method, generally with intersection. For this purpose, the same object point has to be measured in at least two spatially different recording positions. The projection unit here may function as an inverse camera, such that the measurement with one camera is sufficient for determining the 3D coordinates. In many cases, however, it may be helpful to use a plurality of cameras for capturing the projected texture.

DE 10 2012 113 021 A1 describes such a measuring apparatus for the three-dimensional optical measurement of objects with a topometric sensor, that is to say an optical measuring device within the meaning of the present disclosure. In that case, the sensor has a projection unit and an image recording unit, which are arranged in stationary fashion with respect to one another at a common device housing. In order to project patterns with a sufficient brightness, the projection unit has a laser light source.

Instead of a laser light source, however, a sufficient brightness can also be ensured with other light sources, e.g., halogen lamps, short-arc lamps, metal vapor lamps and light-emitting diodes.

In that case, there is a problem of the endangerment of persons without protective equipment, in particular protective goggles, whose eyes may be exposed to the projection beam and who may be injured in the process, particularly if the person looks directly into the light source.

Therefore, optical measuring devices of laser class 3 must be operated only in a protected manner, e.g., in divided-off areas. In that case, a use generally supposes that safety is ensured by a laser safety officer.

CN 102681312 B describes a system for protecting the human eye for a laser projector. In that case, with an ultrasonic sensor, time is measured if an object is positioned between the laser projector and a projection screen in order to dim or switch off the laser projector. The light dose is reduced to a permissible level in this way.

CN 105306856 B describes a safety device for a projector, e.g., a laser microprojector. The safety device has a camera with a field of view that encompasses the projection region. Pattern recognition is used to determine whether an image of a face appears in the field of view of the camera, in order in this case to switch off the light source so as to protect the human eye. An additional infrared sensor can be used to check whether an infrared signal in the field of view matches a thermal signature of the face captured by the camera, in order to avoid false alarms in this way. The infrared sensor may be integrated in the camera.

JP 2014 174 194 A and JP 2014 174 195 A describe a projector with a laser light source for projecting an image onto a projection screen. A sensor for distance measurement detects the distance between an object and the projection opening of the projector in order to dim or switch off the projector if the detected distance of the object is less than a predefined safe distance and the object is thus situated in a hazardous region.

U.S. Pat. No. 10,837,759 B2 describes a 3D measuring device with a sensor for detecting a person who is within a detection region. The measuring device has a laser light source that projects, e.g., a striped light pattern onto an object. If a person is situated within the sensor region for detecting a person, the power of the laser beam is limited. The optical measuring device with the projection unit and a camera is arranged on a robot. Independently thereof, the sensor for detecting the presence of a person is positioned outside this measuring device in such a way that it monitors the area around the robot.

### SUMMARY

Against this background, it is an object of the present disclosure to provide an improved optical measuring device and method for the three-dimensional optical measurement of objects.

The object is achieved by the optical measuring device for the three-dimensional optical measurement of objects and the method for the three-dimensional optical measurement of objects with an optical measuring device as described herein.

It is proposed that the device housing furthermore has a sensor unit for detecting persons in a sensor region captured by the sensor unit, and that the optical measuring device is configured for limiting the light power to a level that is not dangerous for a person situated in a hazardous region to be safeguarded within the projection region, if the presence of a person in the sensor region or part of the sensor region has been detected.

What is achieved by integrating the sensor unit together with the projection unit and the camera unit in one device is that the sensor region and the projection region with a hazardous region always remain assigned to one another, even when the optical measuring device moves in order to carry out the measuring task. This enables the hazardous region to be used as a static sensor region, and enables the sensor region going beyond that to be used partly or completely as a dynamic sensor region. This dynamic sensor region then moves concomitantly with the hazardous region to be safeguarded in the projection region when the position of the optical measuring device is changed.

The hazardous region may be the complete projection region illuminated by the projection unit for projecting a light structure, or else only a partial region thereof which necessitates particular safeguarding owing to its light intensity.

The integration in a device housing should be understood in the sense that projection unit, camera unit and sensor unit are mechanically connected together, for example via a common carrier. In this case, projection unit, camera unit and sensor unit can be secured in or on the device housing formed at least by the carrier.

Within the meaning of the present disclosure, limiting the light power should not just be understood as dimming the light power to a safe level that is not dangerous in respect of endangering a person's eyes. The optical measuring device can also limit the light power by virtue of its being configured for switching off the projection unit if the presence of a person in the sensor region or part thereof has been detected. The illuminance of the projection unit can therefore be not just dimmed to a safe level but if appropriate even completely or partly switched off, in order in this way to reliably prevent endangerment of users who are situated in the hazardous region.

The sensor region is typically larger than the hazardous region to be safeguarded. It does not just encompass the hazardous region as the part to be safeguarded in the projection region, but rather goes beyond that. Therefore, not just the fact of whether a person is situated in the potentially dangerous hazardous region is detected by the sensor. Rather, in this way it is also possible to recognize whether movement of a person from the dynamic sensor region surrounding the hazardous region into the hazardous region will result in a potential hazardous situation.

The sensor unit can be configured to detect persons situated in the projection region by capturing persons in a static sensor region, which corresponds to the hazardous region to be safeguarded. The sensor unit can additionally be configured to detect persons situated outside this hazardous region to be safeguarded by capturing persons in a dynamic sensor region, which surrounds the hazardous region to be safeguarded and corresponds to the dynamic sensor region with the exception of the static sensor region, or hazardous region to be safeguarded, that is encompassed thereby. This is accomplished by the stationary integration of the projection unit and sensor unit in a common device and orientation of the sensor in such a way that the sensor region is larger than the projection region and includes the hazardous region to be safeguarded. The dynamic sensor region going beyond the edges of the hazardous region to be safeguarded makes it possible to protect not just the user who is already situated in the hazardous region, but also persons moving into the hazardous region. The dynamic sensor region ensures a sufficient reaction time to bring about reliable limiting of the light sources in the projection region in the event of a person moving into the hazardous region.

The optical measuring device can be configured to change the extent of the dynamic sensor region in relation to the detection speed and/or a movement speed of a person to be detected or a detected person and/or a movement of the optical measuring device. In this regard, the size of the dynamic sensor region can be adapted to the speed of persons moving in the measurement area, which speed should be expected for use as intended. The extent of the dynamic sensor region can also be adapted to the typical or maximum movement speed of the optical measuring device itself when the latter is moved in order to carry out its measuring tasks. In this regard, it is possible to draw a distinction, e.g., between manually guided and robot-guided optical measuring devices.

The hazardous region to be safeguarded, i.e., the static sensor region, can be determined by the light cones of the projection unit. This can involve, e.g., a cone having a circular or oval cross section or a polygonal pyramid shape. The dynamic sensor region going beyond that can have the same shape as, and a larger extent than, the static sensor region. However, it is also conceivable for the outer contour of the dynamic sensor region to have a different, optionally also asymmetric, shape.

The sensor unit can have, e.g., a radar sensor, a PIR sensor (passive infrared detector) and/or a ToF sensor (time-of-flight camera with photomixing detector—PMD).

Radar sensors are very compact and reliable. They can easily be integrated in an optical measuring device. Radar sensors exhibit a particular sensitivity to water-containing bodies and are less sensitive to inanimate objects, e.g., a measurement object, a measurement link and auxiliary mechanisms, such that a simple distinction between endangered persons and unendangered things thus becomes possible.

PIR sensors are based on passive infrared sensors and can likewise be integrated well. They are available as inexpensive, tried and tested components. PIR sensors make it possible to detect emitted thermal radiation from living beings to a distance of several meters. PIR sensors can be used more easily to recognize not only thermal radiation but also movement of living beings.

A sensor option which is likewise readily available and easily integratable is Time of Flight (ToF) sensors, which capture movements with time-of-flight methods using a 3D camera system. With a light emitting diode or laser diode, a scene is illuminated and is momentarily illuminated with pulses and the time of flight of the individual image points is measured. Infrared light is generally used for this purpose. The illuminated scene is imaged onto an optical sensor configured for time-of-flight measurement. A so-called photomixing detector (PMD sensor) is used for this purpose. In order to reduce interference from background light, an optical bandpass filter allows through substantially only the reflected light with the wavelength which is emitted by the projection unit. A combination of a plurality of sensors and in particular a plurality of different types of sensors makes it possible to further increase safety. By way of example, additional PIR sensors enable moving inanimate parts to be differentiated from a human head.

The sensor unit can be configured to analyze movements of detected persons or things, in order in this way to differentiate endangered persons from unendangered objects (things). In this regard, the sensor unit can have a Doppler radar, with which, simultaneously with the distance measurement of objects, the relative speed of an object with respect to the optical measuring device is determined by way of the frequency shift of the radar signal reflection with respect to the transmitted radar signal.

It is also conceivable to use a pulsed radar, in which a phase shift of the pulses corresponding to the Doppler effect is used for determining speed. A pulsed radar has a very low power consumption owing to the pulse method and makes less stringent requirements of the computing power of the pulse phase evaluation in comparison with the signal frequency evaluation of a traditional Doppler radar.

In a corresponding manner, a movement analysis can also be effected using a ToF sensor, which is likewise based on the fundamental principle of a pulse phase evaluation and at the same time has the advantage of being able to capture an entire scene all at once.

Such a movement analysis makes it possible to differentiate moving, in particular living, objects from static objects. Human beings can always be detected by movement analysis by virtue of their ever present movement, e.g., as a result of tremor, breathing and pulse. This applies in particular to the frontal head, which is particularly relevant to protection against endangerment as a result of excessive light power in the projection region.

Such a sensor device together with a movement analysis makes it possible to carry out measurements in scenes in which inanimate parts, such as measurement object, measurement link, auxiliary mechanism, etc., protrude into the potential hazardous region (hazardous distance).

The sensor unit can have a plurality of redundant sensors of the same kind or of different kinds. The use of a radar sensor allows a plurality of sensors to be used in parallel, without their mutually interfering with one another.

### BRIEF DESCRIPTION OF THE DRAWINGS

The disclosure will now be described with reference to the drawings wherein:

FIG. 1 shows a schematic diagram of a light source with projection lens and a potential hazardous region in the projection region;

FIG. 2 shows a schematic diagram of an optical measuring device with static and dynamic sensor regions; and

FIG. 3 shows a schematic diagram of an optical measuring device with a conical hazardous region and, enclosing the latter, a radar lobe as sensor region.

### DESCRIPTION OF EXEMPLARY EMBODIMENTS

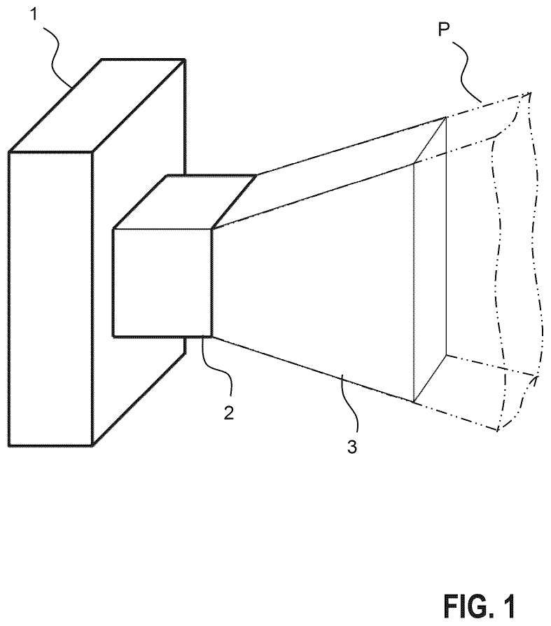

FIG. 1 shows a schematic diagram of a light source 1 of a projection unit for emitting, e.g., laser light or comparatively bright, potentially eye-injuring light (e.g., LED and the like). This light is guided through a projection optical unit 2 in order to emit a projection pattern. The projection region P encompasses a hazardous region 3 (hazardous distance), in which persons' eyes can be injured if the person looks into the light source 1.

Therefore, either it is mandatory for users to wear protective goggles, or the light power has to be limited in the hazardous region 3 in such a way as to preclude endangerment of a person when the latter is situated in the hazardous region 3.

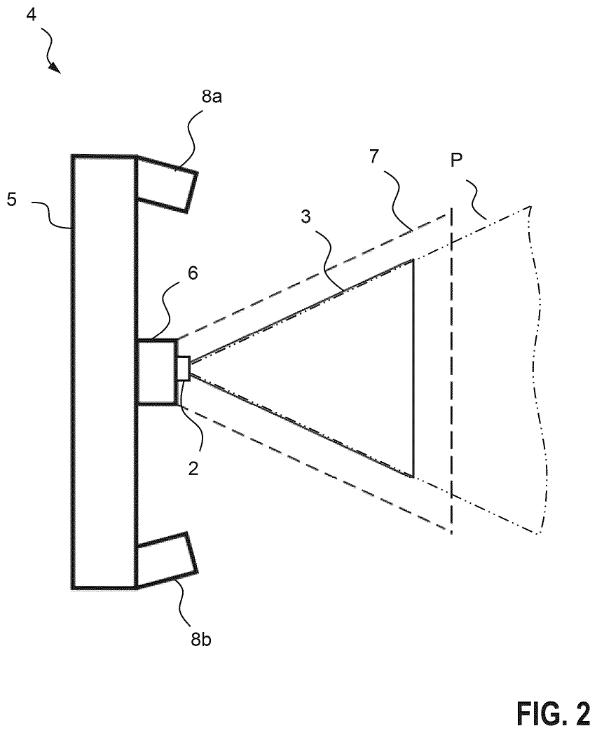

FIG. 2 shows an optical measuring device 4 having a device housing 5. The latter can be configured, e.g., as a simple carrier or as a housing with further components of the optical measuring device 4 fitted therein or thereon.

The optical measuring device 4 has a projection unit 6 having a light source 1 and a projection optical unit 2 in order to project a desired structure in a projection region P onto an object situated there. The projection region P encompasses a hazardous region 3, in which the quantity of light incident on the user's eyes is of sufficient magnitude that the user's eyes are endangered if the user is situated in the hazardous region 3 and in particular looks into the light source 1.

The optical measuring device 4 furthermore has a camera unit, which is formed from two cameras 8a, 8b in the exemplary embodiment illustrated.

The camera unit with its cameras 8a, 8b together with the projection unit 6 with the common device housing 5 are interconnected in such a way that the optical measuring device forms a handleable unit in which the position of camera unit 8a, 8b and projection unit 6 with respect to one another is fixed, even when the projection region P changes as a result of changes in the position of the optical measuring device 4.

The hazardous region 3 forms a static sensor region of a sensor unit (not illustrated). If there is then a person located in this hazardous region 3, the light power of the projection unit 6 is limited in such a way as to reliably preclude endangerment of the person located in the hazardous region 3. This hazardous region 3 constitutes the part to be safeguarded in the projection region P of the projection unit 6 within the meaning of the present disclosure, wherein the hazardous region 3 can also correspond to the complete projection region P.

The region going beyond that, and illustrated by dashed lines, forms a dynamic sensor region 7. The latter is monitored with the aid of the sensor unit in order to recognize a person moving into the hazardous region 3 and to be able to limit the light power in good time before entry into the hazardous region 3. The extent of the dynamic sensor region 7 may firstly be dependent on the expected speed at which a person moves into the hazardous region 3 or the static sensor region. The extent of the dynamic sensor region 7 may secondly also be dependent on the speed of the detection. The speed at which a sensor unit detects persons within the dynamic sensor region 7 can be taken into account in this case. However, one measure for adapting the extent of the dynamic sensor region 7 may also be the movement speed of the optical measuring device 4 itself. For this purpose, the optical measuring device 4 can have an acceleration and/or movement sensor, the signal output of which is used for setting the extent of the dynamic sensor region 7.

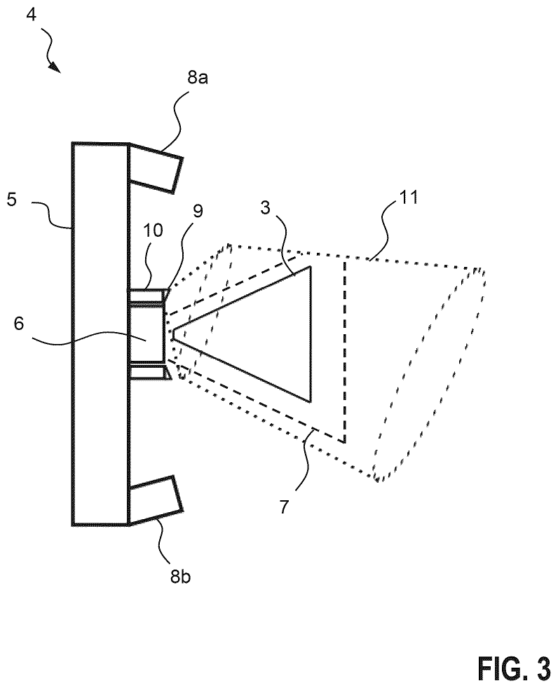

FIG. 3 shows a schematic diagram of the optical measuring device 4. There, too, the projection unit 6 together with the camera unit formed from two cameras 8a, 8b in the exemplary embodiment are integrated in a common device housing 5, i.e., on a common carrier. The projection unit 6, with its projection lens, has a projection region P encompassing the hazardous region 3 as a particularly endangered region to be safeguarded (hazardous distance). The hazardous region 3 can correspond to the projection region P or just be part thereof.

The optical measuring device 4 projects, with a very high brightness, e.g., on the basis of a laser light source, a structure, e.g., a stripe pattern onto an object situated in the projection region P and in particular in the hazardous region 3. The rays reflected by the object are measured by the cameras 8a, 8b and the captured image representation of the object with the patterns projected thereon is evaluated by an evaluation unit (not illustrated) using conventional triangulation methods, in order to measure the object three-dimensionally.

In order to recognize a person in the hazardous region 3 and to reduce the light power to a safe level if a person is present in or enters this hazardous region 3, a sensor unit 9, e.g., having radar sensors is present. The sensor unit 9 is configured to detect, in a sensor region 11 (e.g., radar lobe), the presence of objects and persons with emission of radar signals, reception of reflected radar signals and time-of-flight measurement. In this case, the sensor unit 9 on a sensor mount 10 is integrated in the device housing 5.

It becomes clear that the sensor region 11 encompasses the hazardous region 3, i.e., the part to be safeguarded or else, under certain circumstances, the entire projection region P. This hazardous region 3 to be safeguarded is completely enclosed by the sensor region 11, that is to say the radar lobe. In this way, it becomes possible not just to capture the presence of persons in the static sensor region (i.e., in the hazardous region 3) in order to limit the light power to a safe level or in order to completely switch off the light source of the projection unit 6 if a person is present in said static sensor region (that is to say the projection region to be safeguarded or the hazardous region 3). Rather, with the surrounding dynamic sensor region 7, the inherently safe surroundings of the hazardous region 3 are also monitored in order that the presence and the risk of entry of persons into the hazardous region 3 can be recognized at an early stage.

Therefore, if a user is situated in the hazardous region 3 or the person is imminently about to enter the hazardous region 3, the light power can be limited in such a way that it is possible to operate the optical measuring device 4 in a protection class that is no longer classified as dangerous.

In this regard, it is possible to categorize, e.g., the optical measuring device 4 without monitoring of the hazardous region 3 with a laser light source in the laser class higher than 2 according to DIN EN 60825 or, for other light sources, in the protection class RG-3 according to DIN EN 62471. By virtue of the monitoring of the presence of persons in the hazardous region 3 and in this surrounding dynamic sensor region 7, together with the obligatory limitation of the light power upon detection of a person in the hazardous region 3 and optionally additionally already in the dynamic sensor region 7, this optical device 4 can be classified in a lower protection class, e.g., laser class 2 or RG-2, since the light dose stipulated there is never exceeded owing to the limitation of the light power.

In this case, the light power is typically not limited to zero (switching off), but rather to a noncritical level, such that the light source is always still recognizable and it is clear that the sensor is active.

The sensor region 11, e.g., the radar lobe, can be the physical sensor region in which a person is detectable. It is conceivable for this sensor region 11 still to differ from the dynamic sensor region 7 surrounding the hazardous region 3, i.e., the static sensor region. During the evaluation of the sensor data for the sensor region 11, in order to recognize the presence of potentially endangered persons or objects, it is thus possible to use just part of the technically capturable sensor region 11 in the assessment of the endangerment situation and regulation of the light power of the projection unit 6. The size of this dynamic sensor region 7 to be taken into account can be chosen in particular as a function of the detection speed of the sensor unit 9, the actual or expected movement speed of persons and/or the movement speed of the optical measuring device 4 itself.

What is claimed is:

1. An optical measuring device for the three-dimensional optical measurement of objects, the optical measuring device comprising:
a device housing, in which a projection unit configured to project a measurement structure onto the surface of the object to be measured into a projection region and a camera unit configured to record images of the object provided with the projected measurement structure are integrated,
wherein the device housing has a sensor unit configured to detect persons in a sensor region captured by the sensor unit, and
wherein upon detection of the presence of a person in the sensor region or in a part of the sensor region, the optical measuring device is configured to limit the light power to a level that is not dangerous for a person situated in a hazardous region of the projection region.

2. The optical measuring device as claimed in claim 1, wherein the optical measuring device is configured to switch off the projection unit or reduce the brightness of the projection unit when a presence of a person in the sensor region or part of the sensor region has been detected.

3. The optical measuring device as claimed in claim 1, wherein the sensor region is larger than the hazardous region of the projection region and encompasses the hazardous region.

4. The optical measuring device as claimed in claim 3, wherein the sensor unit is configured to detect persons situated in the hazardous region of the projection region by capturing persons in a static sensor region, which corresponds to the hazardous region, and to detect persons situated outside the hazardous region by capturing persons in a dynamic sensor region, which corresponds to the dynamic sensor region with the exception of the hazardous region encompassed thereby and which is within the entire sensor region.

5. The optical measuring device as claimed in claim 4, wherein the optical measuring device is configured to change the extent of the dynamic sensor region in relation to at least one of the detection speed, a movement speed of a person to be detected or a detected person, and a movement of the optical measuring device.

6. The optical measuring device as claimed in claim 5, wherein the device housing has at least one of a speed, and an acceleration sensor configured to measure at least one of the speed and the acceleration of the device housing and which is configured to set an extent of the dynamic sensor region as a function of at least one of the detected speed and the acceleration of the device housing.

7. The optical measuring device as claimed in claim 1, wherein the projection region and/or the hazardous region are/is determined by the light cone of the projection unit.

8. The optical measuring device as claimed in claim 1, wherein the sensor unit has at least one of a radar sensor, a PIR sensor, and a time-of-flight sensor.

9. The optical measuring device as claimed in claim 1, wherein the sensor unit has a radar sensor and is configured to capture movements of a captured person and to detect a person by virtue of the presence of an object or a person in the sensor region being detected and a movement being captured for the detected presence.

10. The optical measuring device as claimed in claim 9, wherein the radar sensor is a Doppler radar or a pulsed radar.

11. The optical measuring device as claimed in claim 1, wherein the sensor unit has a plurality of redundant sensors.

12. A method for the three-dimensional optical measurement of objects with an optical measuring device as claimed in claim 1, the method comprising:
detecting persons in a sensor region captured by the sensor unit; and
limiting the light power of the projection unit to a level that is not dangerous for a person situated in the hazardous region when the presence of a person in the sensor region or part of the sensor region has been detected.

13. The method as claimed in claim 12, further comprising:
adapting the extent of a dynamic sensor region in relation to the detection speed and/or a movement speed of a person to be detected or a detected person and/or a movement of the optical measuring device,
wherein the dynamic sensor region corresponds to the dynamic sensor region of the sensor unit except for the hazardous region encompassed thereby.

14. The method as claimed in claim 12, further comprising:
switching off the projection unit when the presence of a person in at least one of the sensor region, the part of the sensor region, the dynamic sensor region, and the hazardous region, has been detected.
